(19) United States
(12) Patent Application Publication
(10) Pub. No.: US 2024/0346606 A1
(43) Pub. Date: Oct. 17, 2024

(54) COMPUTER-IMPLEMENTED METHOD FOR EVALUATING APPLICATION THRESHOLD VALUES FOR AN APPLICATION OF A PRODUCT ON AN AGRICULTURAL FIELD

(71) Applicant: BASF AGRO TRADEMARKS GMBH, Ludwigshafen (DE)

(72) Inventors: Hubert Schmeer, Köln (DE); Christian Bitter, Langenfeld (DE); Gauraw Kumar, Münster (DE); Upadhyay Niharika, Kunsal (IN); Carvin Guenther Scheel, Köln (DE); Andreas Gerlach, Köln (DE); Marcel Enzo Gauer, Köln (DE); Clemens Christian Delatree, Münster (DE)

(21) Appl. No.: 18/689,592

(22) PCT Filed: Sep. 6, 2022
(86) PCT No.: PCT/EP2022/074755

§ 371 Date: Mar. 6, 2024

(30) Foreign Application Priority Data
Sep. 8, 2021 (IN) 202121040683
Nov. 10, 2021 (EP) 21207433.0

(51) Int. Cl. G06Q 50/02; G06Q 10/0633

(52) U.S. Cl. CPC G06Q 50/02; G06Q 10/0633

(57) ABSTRACT

Computer-implemented method for evaluating application threshold values for an application of an agricultural product on an agricultural field, comprising the steps: providing field data comprising geographic data about an agricultural field; segmenting at least a part of the agricultural field in sections and assigning different application threshold values for the agricultural product to different sections; applying the agricultural product on the sections according to the assigned application threshold values for the agricultural product; obtaining evaluation data for the different sections representing the effectiveness of the treatment with the different application threshold values; evaluating the different application threshold values at least based on the evaluation data (e.g. efficacy and or yields).

### TECHNICAL FIELD

The present disclosure relates to a computer-implemented method for evaluating application threshold values for an application of an agricultural product on an agricultural field, a method for providing training data for a machine-learning algorithm for evaluating application threshold values in such a method, a neural network trained with such training data, a use of evaluation data and/or section data in such a method, a system for evaluating application threshold values for an application of an agricultural product on an agricultural field and to a computer program element with instructions for carrying out such a method.

### TECHNICAL BACKGROUND

For agricultural management decision as timing, dosing and selection of planting date, crop protection measures, fertilizer application, harvesting operations, etc. a farmer/agronomists usually relies on the recommendations provided by manufacturers of agricultural products, e.g. seeds, growth promoters, fungicides, etc. based on field level. It has become apparent that there is a need to further improve the use of agricultural inputs by intra-field adaptations (on/off or variable rates) in order to provide the best possible use of agricultural products so that, on the one hand, the environment is not disproportionately burdened and, on the other hand, production can be as cost-efficient as possible.

Thus, it is an object of the present invention to provide means, e.g. methods, systems, etc., with which the accuracy of the provided information for an agricultural management decision may be improved. Furthermore, it is an object of the present invention to be able to provide control data for agricultural devices based on this improved information.

These and other objects, which become apparent upon reading the following description, are solved by the subject matter of the independent claims. The dependent claims refer to preferred embodiments of the invention.

### SUMMARY OF THE INVENTION

In one aspect of the present disclosure, a computer-implemented method for evaluating and/or optimizing application threshold values for an application of an agricultural product on an agricultural field, wherein the method comprises at least the following steps:
providing field data comprising geographic data about an agricultural field;
segmenting at least a part of the agricultural field in sections (e.g. trail plots) and assigning different application threshold values for the agricultural product to different sections (e.g. in a replicated, randomized manner);
applying the agricultural product on the sections according to the assigned application threshold values for the agricultural product;
obtaining evaluation data for the different sections representing the effectiveness of the treatment with the different application threshold values;
evaluating the different application threshold values at least based on the evaluation data, such as efficacy in weed control, with the aim to optimize the intra-field product distribution, e.g. in terms of achieving a good performance with the lowest possible input for optimizing the needed resources.

In a further aspect of the present disclosure, a computer-implemented method for evaluating and/or optimizing application threshold values for an application of an agricultural product on an agricultural field, wherein the method comprises at least the following steps:
providing field data comprising geographic data about an agricultural field;
segmenting at least a part of the agricultural field in sections (e.g. trail plots) and assigning different application threshold values for the agricultural product to different sections (e.g. in a replicated, randomized manner);
applying the agricultural product on the sections according to the assigned application threshold values for the agricultural product;
obtaining evaluation data for the different sections representing the effectiveness of the treatment with the different application threshold values;
ranking the different application threshold values at least based on the evaluation data, such as efficacy in weed control, with the aim to optimize the intra-field product distribution, e.g. in terms of achieving a good performance with the lowest possible input,
and optionally using the highest ranked application threshold values as control file usable for controlling an agricultural equipment for treating another agricultural field or other sections of the same agricultural field.

A further aspect of the present disclosure relates to a method for providing training data for a machine-learning algorithm for evaluating application threshold values in said computer-implemented method for evaluating application threshold values for an application of an agricultural product on an agricultural field, wherein the method comprises at least the following steps:
providing application threshold value data for different sections of an agricultural field onto which an agricultural product has been applied according to an application threshold value data;
providing evaluation data for the different sections, wherein the evaluation data represent the effectiveness of the treatment with an application threshold value;
labeling the application threshold value data with the corresponding evaluation data.

A further aspect of the present disclosure relates to a neural network trained with training data obtained according to said method for providing training data for a machine-learning algorithm for evaluating application threshold values.

A further aspect of the present disclosure relates to a use of evaluation data and/or section data in said method for evaluating application threshold values for an application of an agricultural product on an agricultural field.

A further aspect of the present disclosure relates to a system for evaluating application threshold values for an application of an agricultural product on an agricultural field, comprising:
a providing unit configured to provide field data comprising geographic data about an agricultural field;
a segmenting unit configured to segment at least a part of the agricultural field in sections and assigning different application threshold values for the product to different sections;
an agricultural equipment configured to apply the agricultural product on the sections according to the assigned application threshold values for the agricultural product;
an obtaining unit configured to obtain evaluation data for the different sections representing the effectiveness of the treatment with the different application threshold values;
an evaluation unit configured to evaluate the different application threshold values at least based on the evaluation data.

A further aspect of the present disclosure relates to a computer program element with instructions, which, when executed on computing devices of a computing environment, is configured to carry out the steps of said method for evaluating application threshold values for an application of an agricultural product on an agricultural field.

Any disclosure and embodiments described herein relate to the methods, the systems, the treatment devices, the computer program element lined out above and vice versa. Advantageously, the benefits provided by any of the embodiments and examples equally apply to all other embodiments and examples and vice versa.

As used herein “determining” also includes “initiating or causing to determine”, “generating” also includes “initiating or causing to generate” and “providing” also includes “initiating or causing to determine, generate, select, send or receive”. “Initiating or causing to perform an action” includes any processing signal that triggers a computing device to perform the respective action.

Therefore, through the present disclosure, it is possible to determine an optimization of threshold values for the use of an agricultural product that enables an optimal/best balance between product use/product saving and product performance (e.g. efficacy, crop yield, etc.). These optimized thresholds can then be used to control agricultural equipment. As will be explained in the following, the optimized threshold values obtained in this way can additionally be correlated with location-specific data/section data to allow further optimization/specification of the threshold values. Thus, by means of the present disclosure, an intra-field distribution of an agricultural product (“teilflächenspezifische Anwendung”, intra-field devaluation) using a computer program element with instructions for carrying out such a method can be provided.

### Definitions

The term “agricultural product” is generally to be understood broadly in the present disclosure and comprises any object or material useful/required for the treatment of an agricultural field and whose application may be carried out by a threshold-based application. In the context of the present disclosure, the term agricultural product includes but is not limited to:
chemical products such as fungicide, herbicide, insecticide, acaricide, molluscicide, rodenticide, repellant, bactericide, biocide, safener, plant growth regulator, urease inhibitor, nitrification inhibitor, denitrification inhibitor, or any combination thereof;
biological products such as microorganisms useful as fungicide (biofungicide), herbicide (bioherbicide), insecticide (bioinsecticide), acaricide (bioacaricide), molluscicide (biomolluscicide), rodenticide, repellant, bactericide, biocide, safener, plant growth regulator, urease inhibitor, nitrification inhibitor, denitrification inhibitor, or any combination thereof;
fertilizer and nutrient;
seed and seedling;
water;
agricultural equipment/devices, e.g. sprayers, harvesters, machines, and spare parts for such equipment/devices; and/or
any combination thereof.

The term “threshold values” is to be understood broadly and comprises and numerically measurable/providable variable, which can be used as threshold, such as a weed density, plant heights, biomass data and/or any measurable vegetation indices. These threshold values are usually used to control an application/agricultural device in such a way that no application takes place when the measured variable value is below the threshold value and an application takes place when the measured value is above the threshold value. Such an application is typically referred to as an on-off application. In addition, it is also possible to provide several threshold values or a threshold function with different or variable application rates.

The term “applying the agricultural product on the sections according to the assigned application threshold values for the agricultural product” may preferably be understood in such a way that the agricultural product is only applied on the corresponding section in case the assigned application threshold values for the agricultural product has been exceeded.

The term “agricultural field” means an area that is used for the cultivation of agricultural crop plants, for example, wheat, corn, etc. The “field data” is to be understood as data comprising at least the geographical information of the respective agricultural field, e.g. provided as so called shape file and/or field metadata.

“Segmenting of at least a part of the agricultural field in sections” is to be understood as dividing the agricultural field into different subareas, such as individual plots or stripes. Preferably, the agricultural field is segmented into at least two, more preferably at least 4, most preferably at least 6, particularly preferably at least 8, particularly more preferably at least 10, particularly most preferably at least 15, particularly at least 20 subareas, such as individual plots or stripes. Thereby, only a part of the agricultural field can be divided into such segments, or the entire agricultural field can be divided into such segments. In the following, an example for providing/calculating a stripe or plot design is explained. A spatial container, i.e. the field boundary, is provided by means of the field data. Subsequently, a tramline entry point and a tramline degree is chosen, usually based on the longest natural axis of the field, i.e. the tramline direction. Then, a strip design/pattern can be placed over the field based on the tramline entry point and the tramline direction, wherein the strip width is either preset or entered manually by a farmer as part of the test data. For the plot design, the strips are further divided, usually in regular plots. The tramline entry point is a point within the field, where the tramline (working line, driving lane) of the field equipment is identify. This should coincide with the center of the application machinery, such as the center of gravity point of an agricultural machine, e.g. a seeder, sprayer, etc. Notably, whether or not this marks the top, center or bottom in driving direction is not immensely important, since the full-field is traced out. The tramline enter degree is the driving orientation of the agricultural machine through the field. In practice, this typically coincides with the longest natural straight direction within the field. However, for fields that are more irregularly shaped, multiple such directions may exist. In such a case, it is preferred that the field is split into multiple virtual fields, as single tramlines are easier to handle. Notably, this provided strip or plot design can be reused and the exact same positions can be used at different application times.

Alternatively or in addition, permanent or temporary, so called geo-referenced AB-lines maybe used, if available to align the trial plots/stripes instead of using the above-described method.

Notably, it is preferred that a “completely randomized block design” of the segments is provided. This means that a single contiguous block is first defined on the agricultural field, which is then subdivided into neighboring plots, where not all plots are assigned different threshold values, but a certain number of plots is assigned one threshold value, and another number of plots is assigned another threshold value, and so on. For example, 28 plots can be defined in such a contiguous area. Different threshold values can be assigned to a set of four blocks/plots providing a statistically advantageous repetition (cf. FIG. 3). The threshold values can be assigned to the plots randomly, whereby certain conditions may be set, e.g. that not all threshold values are assigned to neighboring plots, to improve the informative value of the data obtained. Thus, for example, seven threshold values can be examined on such a field/block. However, the present disclosure is not limited to a certain size of such a block and/or to the number of repetitions or to the number of threshold values to be examined. However, such an approach is preferred, since statistically well evaluable results can be provided thereby.

The term “evaluation data” refers to any data that can be used to draw conclusions about the effectiveness of the treatment with the different threshold values, i.e. to be able to determine the effect of the different threshold values. This can be, for example, weed density data, yield data, data with respect to the effect of the different thresholds on certain vegetation indices, efficacy data, gross margin data, etc. The term “yield” is the harvested plant or crop biomass (e.g. indicated in tons or kilograms) per area unit (e.g. indicated in hectare or square meters) and per vegetation period (e.g. season), and yield is indicated for example as tons per hectare or kilograms per hectare. Notably, the term “yield” in the present disclosure can mean both, the so called “biological yield” and the so called “economic yield”. The “biological yield” is defined as “the total plant mass, including roots (biomass), produced per unit area and per growing season”. For the “economic yield”, “only those plant organs or constituents” are taken into account “around which the plant is grown”, wherein “a high biological yield is the basis for a high economic yield” (see Hans Mohr, Peter Schopfer, Lehrbuch der Pflanzenphysiologie, 3rd edition, Berlin/Heidelberg 1978, p. 560-561). “Effects on certain vegetation indices” encompasses in particular a comparison of a vegetation index before and after a treatment. For example, in a first year the LAI (Leaf Area Index) of the respective area/field can be determined and compared with an LAI of the area/field in a second year. The skilled person knows a plurality of such vegetation indices that might be of interest. Not conclusive can be mentioned here for example: DVI (Difference Vegetation Index), RVI (Ratio Vegetation Index), NDVI (Normalized Differenced Vegetation Index), EVI (Enhanced Vegetation Index), GRABS (Greenness Above Bare Soil), etc. The term “efficacy” can be understood as an equation in which the positive effects of the treatment in performing the desired plant protection activity (e.g. controlling the target pest or modifying crop growth) and any other useful effect, such as controlling other non-target pests, are balanced against the negative effects, such as direct damage to the crop (phytotoxicity) or effects on pollinators and natural enemies, or development of resistance. A “gross margin” may be determined by deducting the direct costs of growing a crop from the gross income for a crop. Direct costs typically include those associated with crop production operations, harvesting and marketing. Gross margins do not include overhead costs such as rates, living costs, insurance, that must be met regardless of whether or not a crop is grown. For this reason gross margins are not a measure of the profit of a particular enterprise. However, for an agronomic gross margins provide a useful tool in terms of farm budgeting and estimating the likely returns or losses of a particular crop. Gross margins allow a skilled person to compare the relative profitability of alternative cropping options that have similar land, machinery and equipment requirements.

The term “evaluating” may be preferably understood as “assessing”, “ranking”, or “validating”, more preferably as “ranking”.

The term “section data” is to be understood as any data referring to the agricultural field or the block which is randomized. For example, various data layers with respect to a parameters of the field may be generated/provided (e.g. a data layer for the soil texture of the field, a data layer for electrical conductivity of the field, a data layer for the topography of the field, etc. may be generated/provided). It is possible to use only some of these data layers, i.e. different data layers of the generated/provided data layers, which appear to be decisive for a particular field may be “selected” and combined with the evaluation data. Moreover, the different data layers may be weighted differently.

The term “machine-learning algorithm” is to be understood broadly and preferably comprises decision trees, naive bayes classifications, nearest neighbors, neural networks, convolutional neural networks, generative adversarial networks, support vector machines, linear regression, logistic regression, random forest and/or gradient boosting algorithms. Preferably, the machine-learning algorithm is organized to process an input having a high dimensionality into an output of a much lower dimensionality. Such a machine-learning algorithm is termed “intelligent” because it is capable of being “trained”. The algorithm may be trained using records of training data. A record of training data comprises training input data and corresponding training output data. The training output data of a record of training data is the result that is expected to be produced by the machine-learning algorithm when being given the training input data of the same record of training data as input. The deviation between this expected result and the actual result produced by the algorithm is observed and rated by means of a “loss function”. This loss function is used as a feedback for adjusting the parameters of the internal processing chain of the machine-learning algorithm. For example, the parameters may be adjusted with the optimization goal of minimizing the values of the loss function that result when all training input data is fed into the machine-learning algorithm and the outcome is compared with the corresponding training output data. The result of this training is that given a relatively small number of records of training data as “ground truth”, the machine-learning algorithm is enabled to perform its job well for a number of records of input data that higher by many orders of magnitude.

The term “computer program element” is to be understood broadly, wherein the computer program element might be stored on a computer unit, which might also be part of an embodiment. This computing unit may be configured to perform or induce performing of the steps of the methods described above. Moreover, it may be configured to operate the components of the above described apparatus and/or system. The computing unit can be configured to operate automatically and/or to execute the orders of a user. A computer program may be loaded into a working memory of a data processor. The data processor may thus be equipped to carry out the method according to one of the preceding embodiments. This exemplary embodiment of the present disclosure covers both, a computer program that right from the beginning uses the invention and computer program that by means of an update turns an existing program into a program that uses invention. Further on, the computer program element might be able to provide all necessary steps to fulfill the procedure of an exemplary embodiment of the methods as described above. According to a further exemplary embodiment of the present disclosure, a computer readable medium, such as a CD-ROM, USB stick or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described aspects/embodiments of the present disclosure.

In an embodiment of the computer-implemented method for evaluating application threshold values for an application of an agricultural product on an agricultural field, applying the agricultural product on the sections is performed by an agricultural equipment configured to apply the agricultural product in an on/off manner, e.g. for herbicide spot treatments in an variable rate mode and for plant growth regulators and fungicides.

For example, spraying devices/systems may comprise sensor means for recognizing the green weed and measure the surface to take a decision to spray. In a way a green area index or leaf area index is calculated to take decisions based on threshold values which are based weed coverage (e.g. on % green on green or in other words square cm per square meter).

In an embodiment of the computer-implemented method for evaluating application threshold values for an application of an agricultural product on an agricultural field, the different sections have the shape of plots and/or strips, preferably with an area of at least a sprayer, spreader or seeder, e.g. between 1.5 m and 10 m and a length of at least 50 m but with combinable crops preferably more than 100 m.

In an embodiment of the computer-implemented method for evaluating application threshold values for an application of an agricultural product on an agricultural field, the agricultural equipment comprises at least one sensor means, e.g. an optical sensor, configured to determine during the application of the agricultural product whether the respective application threshold value is exceeded or not exceeded.

In an embodiment of the computer-implemented method for evaluating application threshold values for an application of an agricultural product on an agricultural field:
the agricultural product is a plant growth regulator and/or a fungicide and the application threshold value is a Green Area Index (GAI) and/or a Leaf Area Index (LAI);
the agricultural product is a seed and the application threshold value is at least one soil property value (e.g. a soil property of a lower soil layer, e.g. below 60 cm) and/or a yield potential value (e.g. long term LAI or historic yields; historical biomass data, which correlates well with the soil property of the lower soil layers) and/or landscape parameter as elevation;
the agricultural product is a fertilizer and the application threshold value is at least one soil property value (e.g. nitrate level in spring; or a vegetation index as NDVI (e.g. a red edge value);
the agricultural product is a nematicide and the application threshold value is nematode threshold value linked to damage symptoms on the crop canopy surface; and/or
the agricultural product is an insecticide and the application threshold value is a value of camera detected insects and/or damages.

In an embodiment of the computer-implemented method for evaluating application threshold values for an application of an agricultural product on an agricultural field, the evaluation data comprise:
weed density data and weed distribution data or weed coverage data;
yield data;
biomass data and/or vegetation indices data selected from: Leaf Area Index (LAI) data, which is one of the most preferred indices, Normalized Difference Vegetation Index (NDVI) data, Green Normalized Difference Vegetation Index (GNDVI) data, Soil Adjusted Vegetation Index (SAVI) data, Normalized Difference Water Index (NDWI) data, and/or a combination therefrom;
plant disease level data;
pest level data;
level of damage symptoms on the crop canopy surface (e.g. in rotation or yellow leave 12); and/or
canopy height data.

In an embodiment of the computer-implemented method for evaluating application threshold values for an application of an agricultural product on an agricultural field, the evaluation data is obtained by in situ measurements and/or remote measurements.

For example evaluation data can be collected/provided by a person, e.g. by a visual assessment. Such visual assessments are often done to have a so called “ground truthing” of machinery data versus existing experience of a good field performance. Notably, in situ measurements can be done by: harvester yield maps, agricultural equipment comprising respective sensor means, etc. and/or by remote measurements using an image analysis (e.g. based on applicators mounted camera systems, on drone or satellite images), remote radar (SAR, LIDAR) or infrared sensors, etc.

In an embodiment of the computer-implemented method for evaluating application threshold values for an application of an agricultural product on an agricultural field, the method further comprises the step of providing section data for the different sections comprising data relating to characteristics of a respective section. Beside the evaluation data, these section data can additionally be used in the analysis/evaluation of the application threshold values, i.e. the threshold values can be evaluated in view of a combination of the evaluation data and the section data. For example, in case the threshold value is a weed threshold value as section data historical weed data may be used, e.g. in form of historical weed distribution maps.

In an embodiment of the computer-implemented method for evaluating application threshold values for an application of an agricultural product on an agricultural field, the section data comprise:
long term crop Leaf Area Index (LAI) data;
soil data selected from: electrical conductivity data, soil type data, soil texture data, soil organic matter data, plant available water capacity data, nutrient data, cation exchange capacity data, topography data, nitrogen content data, cation-exchange capacity data, potassium content data, phosphorus level data, pH value data, and/or a combination therefrom;
historic weed distribution data and particularly for problem wees, preferably comprising information with respect to weed hot spots/weed patches (e.g. Field Foxtail (“Ackerfuchsschwanz”); and/or
pretreatment data, whether and how an area was pretreated (e.g. plowed or unplowed);
wherein the section data is preferably provided as in field distributions in form of a respective map (e.g. an intra-field map).

In an embodiment of the computer-implemented method for evaluating application threshold values for an application of an agricultural product on an agricultural field, the step of evaluating the different application threshold values is at least based on the evaluation data and the section data.

In an embodiment of the computer-implemented method for evaluating application threshold values for an application of an agricultural product on an agricultural field, the step of evaluating the different application threshold values comprises the execution of an evaluation algorithm, which is preferably based on the results of a machine-learning algorithm.

In an embodiment of the method for providing training data for a machine-learning algorithm for evaluating application threshold values in said computer-implemented method for evaluating application threshold values for an application of an agricultural product on an agricultural field, the method further comprises the steps:
providing section data for the different sections for the different sections comprising data relating to characteristics of a respective section;
labeling the application threshold value data with the corresponding evaluation data and section data.

### BRIEF DESCRIPTION OF THE DRAWINGS

In the following, the present disclosure is further described with reference to the enclosed figures:

FIG. 1 is a flow diagram of an example method for evaluating application threshold values for an application of an agricultural product on an agricultural field;

FIG. 2 is a schematic illustration of an example system for evaluating application threshold values for an application of an agricultural product on an agricultural field;

FIG. 3 is a schematic illustration of an example of a complete randomized block in an agricultural field;

FIG. 4 is a schematic illustration of an example of section data of an agricultural field in form of a biomass map/biomass data;

FIG. 5 is a schematic illustration of exemplary communication paths by which instructions and/or control data can be transmitted to an agricultural equipment; and hand-held data loggers;

FIG. 6 is a schematic illustration of the different possibilities to obtain from connected agricultural implements and process field data.

### DETAILED DESCRIPTION OF EMBODIMENT

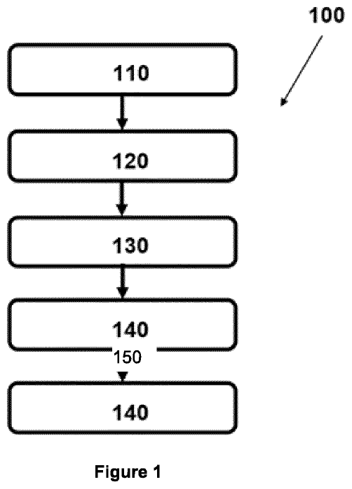

FIG. 1 is a schematic overview of a method 100 for evaluating application threshold values for an application of an agricultural product on an agricultural field according to the preferred embodiment of the present disclosure. In the following, an exemplary order of the steps according to the preferred embodiment of the present disclosure is explained.

In a step S110, field data comprising geographic data about an agricultural field are provided, e.g. provided as so called shape file and/or field metadata.

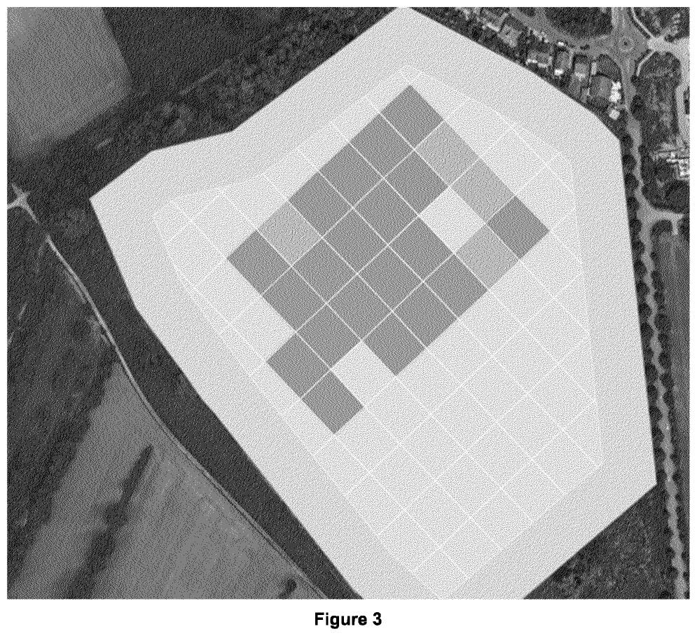

In a step S120, at least a part of the agricultural field is segmented in sections and different application threshold values for the agricultural product are assigned to different sections. In the preferred embodiment, a so called “complete randomized block” design” (Completely Randomized Block Design (CRBD)) of the segments is provided as exemplarily shown in FIG. 3. This means that a single contiguous block is first defined on the agricultural field, which is then subdivided into neighboring plots, where not all plots are assigned different threshold values, but a certain number of plots is assigned one threshold value, and another number of plots is assigned another threshold value, and so on. In the shown example, 28 plots have been defined in such a contiguous area. Different threshold values can be assigned to a set of four plots providing a statistically advantageous repetition. The threshold values can be assigned to the plots randomly, whereby certain conditions may be set, e.g. that not all threshold values are assigned to neighboring plots, to improve the informative value of the data obtained. Thus, for example, seven threshold values can be examined on such a trial block. However, the present disclosure is not limited to a certain size of such a block and/or to the number of repetitions or to the number of threshold values to be examined. However, such an approach is preferred, since statistically well evaluable results can be provided thereby. In the preferred embodiment of the present disclosure, the following weed threshold values weed thresholds have been assigned to a set of four blocks lots: In a step S130, the agricultural product is applied on the sections according to the assigned application threshold values for the agricultural product. In the preferred embodiment, the agricultural product is a herbicide and the application threshold value is a weed threshold value. In this respect, it is preferred that for example a spraying device/system comprises sensor means for recognizing the green weed and measures the surface to take a decision to spray or not. In a way a green area index or leaf area index is calculated to take decisions based on the weed threshold values, e.g. on % green on green or in other words square cm per square meter.

In a step S140, evaluation data for the different sections representing the effectiveness of the treatment with the different application threshold values is obtained. The evaluation data is data allowing a conclusion about the effectiveness of the treatment with the different threshold values. In the preferred embodiment of the present disclosure, the evaluation data is provided in form of weed data (e.g. weed density data), i.e. after a certain time period (e.g. between 1 day and 2 weeks), it is determined how much weed is still present in the different plots. The evaluation data may be collected/provided by a person, e.g. by a visual assessment. Notably, in situ measurements can be done by: harvester yield maps, agricultural equipment comprising respective sensor means, etc. and/or by remote measurements using an image analysis (e.g. based on applicators mounted camera systems, on drone or satellite images), remote radar (SAR, LIDAR) or infrared sensors, etc.

Based on this obtained evaluation data, here in form of weed data, in a step S150, the different application threshold values can be evaluated at least based on the evaluation data. Depending on the application, the evaluation can be carried out from different points of view, for example in the form of a cost-benefit analysis or a plateau-analysis/saturation analyses, i.e. at which threshold value there are no longer noticeable changes, for example in the application of plant growth products.

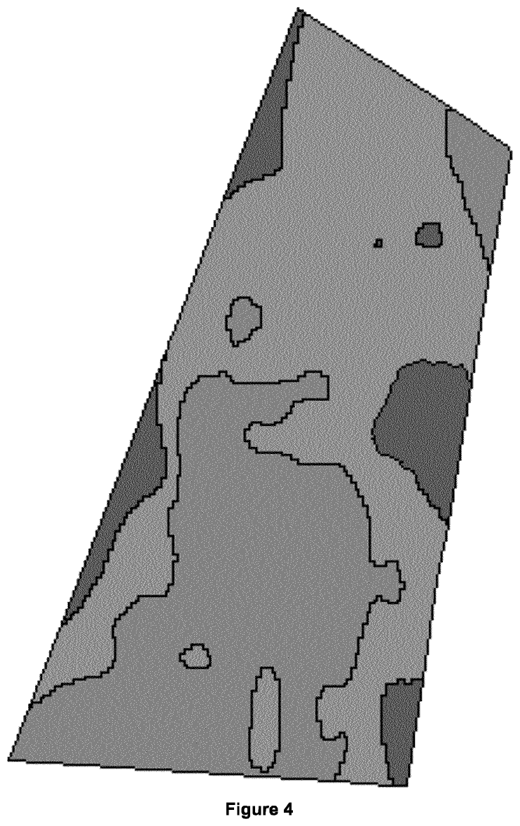

Optionally, further section data maybe provided referring to characteristics of the actual agricultural field or the block, which has been randomized. For example, various data layers with respect to a parameters of the field may be generated/provided (e.g. a data layer for the soil texture of the field, a data layer for electrical conductivity of the field, a data layer for the topography of the field, etc. may be generated/provided). It is possible to use only some of these data layers, i.e. different data layers of the generated/provided data layers, which appear to be decisive for a particular field may be “selected” and combined with the evaluation data. Moreover, the different data layers may be weighted differently. In the preferred embodiment of the present disclosure, as section data biomass data may be used illustrating/representing the general performance of the agricultural field or the individual plots. The section data is preferably provided as in field distributions in form of a map (e.g. an intra-field map), here in form of a biomass distribution map as exemplarily shown in FIG. 4. In addition or as an alternative, as section data historical weed distribution data, e.g. in form of a weed distribution map showing also the weed hot spots, can be provided.

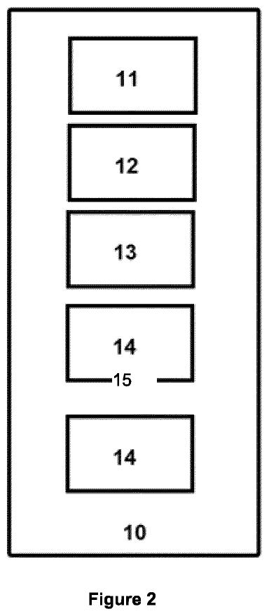

FIG. 2 is a schematic illustration of an example system 10 for evaluating application threshold values for an application of an agricultural product on an agricultural field. The system comprises:
a providing unit 11 configured to provide field data comprising geographic data about an agricultural field;
a segmenting unit 12 configured to segment at least a part of the agricultural field in sections and assigning different application threshold values for the product to different sections;
an agricultural equipment 13 configured to apply the agricultural product on the sections according to the assigned application threshold values for the agricultural product;
an obtaining unit 14 configured to obtain evaluation data for the different sections representing the effectiveness of the treatment with the different application threshold values;
an evaluation unit 15 configured to evaluate the different application threshold values at least based on the evaluation data.

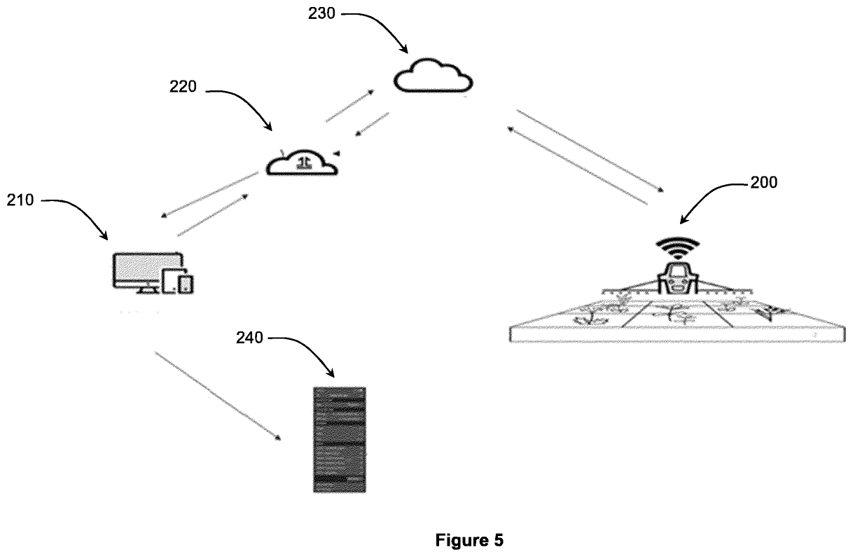

FIG. 5 illustrates the exemplary communication paths by which instructions and/or control data (for example, in the form of an application map, e.g. a “to-be-applied map”) can be transmitted to an agricultural equipment 200 (for example, a sprayer 200). For example, an application map may be generated in a computing unit 210 and transmitted to the agricultural equipment 200 via a work platform 220 and/or a cloud application 230. Alternatively, or in addition, a transfer to the agricultural equipment can be made via a USB connection or via a wireless connection with a mobile device 240.

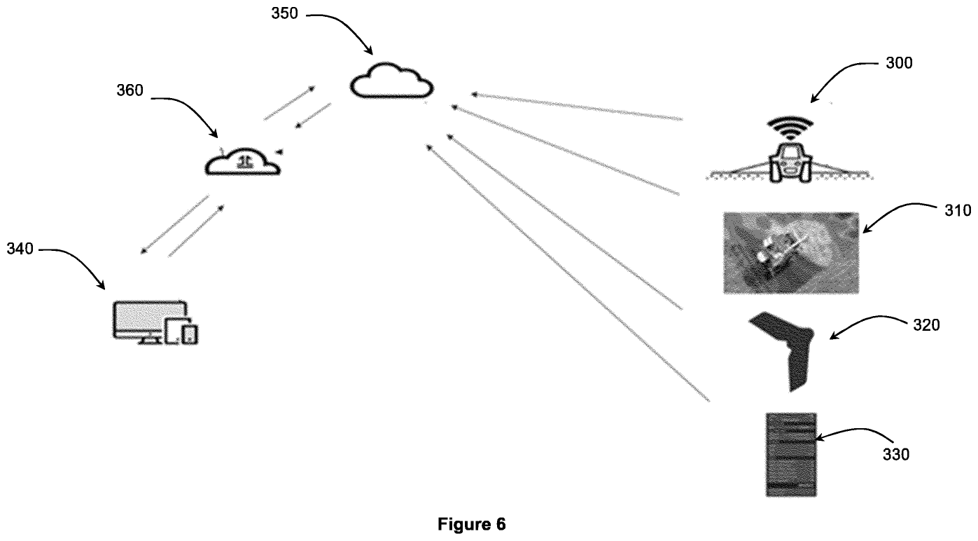

FIG. 6 illustrates exemplarily the different possibilities to receive and process field data. For example, field data can be obtained by all kinds of agricultural equipment 300 (e.g. a sprayer 300) as so-called as-applied maps by recording the application rate at the time of application. It is also possible that such agricultural equipment comprises sensors (e.g. optical sensors, cameras, infrared sensors, etc.) to provide, for example, a weed distribution map. It is also possible that during harvesting the yield (e.g. in the form of biomass) is recorded by a harvesting vehicle 310. Furthermore, corresponding maps/data can be provided by land-based and/or airborne drones 320 by taking images of the field or a part of it. Finally, it is also possible that a geo-referenced visual assessment 330 is performed and that this field data is also processed. Field data collected in this way can then be merged in a computing device 340, where the data can be transmitted and computed, for example, via any wireless link, cloud applications 350 and/or working platforms 360, wherein the field data may also be processed in whole or in part in the cloud application 350 and/or in the working platform 360 (e.g., by cloud computing).

Aspects of the present disclosure relates to computer program elements configured to carry out steps of the methods described above. The computer program element might therefore be stored on a computing unit of a computing device, which might also be part of an embodiment. This computing unit may be configured to perform or induce performing of the steps of the method described above. Moreover, it may be configured to operate the components of the above described system. The computing unit can be configured to operate automatically and/or to execute the orders of a user. The computing unit may include a data processor. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick, a downloadable executable or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for evaluating application threshold values for an application of an agricultural product on an agricultural field, comprising the following steps:
providing field data comprising geographic data about an agricultural field;
segmenting at least a part of the agricultural field in sections and assigning different application threshold values for the agricultural product to different sections;
applying the agricultural product on the sections according to the assigned application threshold values for the agricultural product;
obtaining evaluation data for the different sections representing the effectiveness of the treatment with the different application threshold values; and
evaluating the different application threshold values at least based on the evaluation data.

2. The method according to claim 1, wherein applying the agricultural product on the sections is performed by an agricultural equipment configured to apply the agricultural product in an on/off manner.

3. The method according to claim 2, wherein the agricultural equipment comprises at least one sensor configured to determine during the application of the agricultural product whether the respective application threshold value is exceeded or not exceeded.

4. The method according to claim 1, wherein
the agricultural product is a herbicide and the application threshold value is a weed threshold value and/or a relative value of crop area in relation to weed area;
the agricultural product is a plant growth regulator and/or a fungicide and the application threshold value is a Green Area Index (GAI) or a Leaf Area Index (LAI);
the agricultural product is a seed and the application threshold value is at least one soil property value and/or a yield potential value and/or landscape parameter as elevation;
the agricultural product is a fertilizer and the application threshold value is at least one soil property value e.g. nitrate level in spring; or a vegetation index as NDVI;
the agricultural product is a nematicide and the application threshold value is nematode threshold value linked to damage symptoms on the crop canopy surface; and/or
the agricultural product is an insecticide and the application threshold value is a value of camera detected insects or damage symptoms on the crop canopy surface.

5. The method according to claim 1, wherein the evaluation data comprise:
weed density data or weed coverage data;
yield data;
biomass data and/or vegetation indices data selected from: Leaf Area Index (LAI) data, Normalized Difference Vegetation Index (NDVI) data, Green Normalized Difference Vegetation Index (GNDVI) data, Soil Adjusted Vegetation Index (SAVI) data, Normalized Difference Water Index (NDWI) data, and/or a combination therefrom;
plant disease level data;
pest level data;
level of damage symptoms on the crop canopy surface; and/or
canopy height data.

6. The method according to claim 1, wherein the evaluation data is obtained by in situ measurements and/or remote measurements.

7. The method according to claim 1, wherein the method further comprises the step of providing section data for the different sections comprising data relating to characteristics of a respective section.

8. The method according to claim 7, wherein the section data comprise:
long term crop Leaf area index (LAI) data;
soil data selected from: electrical conductivity data, soil type data, soil texture data, soil organic matter data, plant available water capacity data, nutrient data, cation exchange capacity data, topography data, nitrogen content data, cation-exchange capacity data, potassium content data, phosphorus level data, pH value data and/or a combination therefrom;
historic weed distribution data and particularly for problem weeds information with respect to weed hot spots/weed patches; and
pretreatment data, whether and how an area has been pretreated,
wherein the section data is provided as intra-field distributions in form of a map.

9. The method according to claim 7, wherein the step of evaluating the different application threshold values is at least based on the evaluation data and the section data.

10. The method according to claim 1, wherein the step of evaluating the different application threshold values comprises the execution of an evaluation algorithm, which is based on the results of a machine-learning algorithm.

11. A method for providing training data for a machine-learning algorithm for evaluating application threshold values in a method according to claim 1, comprising the steps:
providing application threshold value data for different sections of an agricultural field onto which an agricultural product has been applied according to an application threshold value data;
providing evaluation data for the different sections, wherein the evaluation data represent the effectiveness of the treatment with an application threshold value; and
labeling the application threshold value data with the corresponding evaluation data.

12. A neural network trained with training data provided according to claim 11.

13. Use of evaluation data and/or section data in a method according to claim 1.

14. A system for evaluating application threshold values for an application of an agricultural product on an agricultural field, the system comprising:
a providing unit configured to provide field data comprising geographic data about an agricultural field;
a segmenting unit configured to segment at least a part of the agricultural field in sections and assigning different application threshold values for the product to different sections;
an agricultural equipment configured to apply the agricultural product on the sections according to the assigned application threshold values for the agricultural product;
an obtaining unit configured to obtain evaluation data for the different sections representing the effectiveness of the treatment with the different application threshold values; and
an evaluation unit configured to evaluate the different application threshold values at least based on the evaluation data.

15. A non-transitory computer readable medium having instructions encoded thereon, which, when executed on computing devices of a computing environment, cause the computing devices to carry out the steps of the method according to claim 1.
